(19) United States
(12) Patent Application Publication
(10) Pub. No.: US 2017/0122523 A1
(43) Pub. Date: May 4, 2017

(54) LED LENS AND LED LIGHT SOURCE COMPRISING LED LENS

(71) Applicant: SUZHOU DONGSHAN PRECISION MANUFACTURING CO., LTD., Suzhou (CN)

(72) Inventors: Xiufu Li, Suzhou (CN); Yonggang Yuan, Suzhou (CN)

(21) Appl. No.: 15/128,229

(22) PCT Filed: Jun. 19, 2014
(86) PCT No.: PCT/CN2014/080264

§ 371 Date: Sep. 22, 2016

(51) Int. Cl. F21V 5/00; F21V 5/04

(52) U.S. Cl. CPC F21V 5/002; F21V 5/04; F21Y 2115/10

(57) ABSTRACT

An LED lens and an LED light source having the LED lens are provided. The LED lens has a central curved surface and a bottom surface both located at an incident plane, a side surface, first and second upper curved surfaces all located at an emergent plane, and scattering microstructures located on the first and second upper curved surfaces. The positions of the scattering microstructures correspond to bright rings in LED light intensity distribution, scatter light that emerges out of the first and second upper curved surfaces and forms the bright rings. Therefore, the light at the bright rings is slightly scattered, light intensity at the bright rings is reduced, light intensity at dark rings of the LED light source is improved, and uniformity of light intensity distribution of the LED light source can be improved.

### FIELD

The present disclosure relates to the technical field for fabricating an LED lens, and in particular to an LED lens and an LED light source including the LED lens.

### BACKGROUND

An LED is a point light source emitting a light beam with a certain angle. Hundreds of, even thousands of tricolor LEDs are arranged in an array to form a surface light source, which functions as a backlight source of a direct-type liquid crystal display. A key technology of the LED backlight source is to transform the point light source into a uniform surface light source. In the conventional technology, generally a lens is installed on the LED to change LED light intensity distribution.

As shown in FIG. 1, the conventional LED lens is an axisymmetric rotation entity. The LED lens includes: an incident surface, where the incident surface includes a central curved surface 01 located at a center of the LED lens and a bottom surface 02 located around the central curved surface 01 and connected to the central curved surface 01, and the central curved surface 01 is a spherical cap curved surface; and an emergent surface, where the emergent surface includes a lateral surface 03 perpendicular to and connected to the bottom surface 02, and a first upper curved surface 04 and a second upper curved surface 05 connected to the lateral surface 03, and the first upper curved surface 04 and the second upper curved surface 05 are connected to each other and are symmetrical relative to an axis of the LED lens, thereby transforming point light source light emitted from the LED into surface light source light using the LED lens.

However, light emitted from the LED has poor uniformity after being transmitted from the LED lens.

### SUMMARY

In order to address the technical issues above, an LED lens and an LED light source including the LED lens are provided according to embodiments of the present disclosure, so as to improve uniformity of light intensity distribution of the LED light source.

In order to address the above issues, technical solutions are provided according to the embodiments of the present disclosure hereinafter.

An LED lens is provided, which includes:

an incident surface, where the incident surface includes a central curved surface located at a center of the LED lens and a bottom surface located around the central curved surface and connected to the central curved surface; and

an emergent surface, where the emergent surface includes a lateral surface perpendicular to and connected to the bottom surface and a first upper curved surface and a second upper curved surface connected to the lateral surface, and the first upper curved surface and the second upper curved surface are connected to each other and are symmetrical relative to an axis of the LED lens,

where the LED lens further includes:

scattering micro-structures located on the first upper curved surface and the second upper curved surface, where the scattering micro-structures have positions corresponding to positions of bright rings in LED light intensity distribution, and scatter light transmitted from the first upper curved surface and the second upper curved surface and forming the bright rings.

Preferably, the scattering micro-structures may be located in a region in which an angle between the lateral surface and the bottom surface has a range of 60 degrees to 90 degrees, inclusive.

Preferably, the scatter micro-structure may be a ring-shaped structure parallel to the bottom surface.

Preferably, projections of adjacent ones of the scattering micro-structures on the bottom surface may adjoin end to end.

Preferably, a distance between two ends of the scattering micro-structure may be greater than 0 μm and less than or equal to 100 μm.

Preferably, the scattering micro-structure may be an axisymmetric structure.

Preferably, the LED lens may be fabricated using an injection molding process.

An LED light source is provided, which includes an LED light-emitting chip and the LED lens described above, where the LED light-emitting chip is located within a cavity formed by the central curved surface and the bottom surface of the LED lens, and the scattering micro-structures in the LED lens have positions corresponding to positions of bright rings in LED light intensity distribution of the LED light-emitting chip.

As compared with the conventional technology, the above technical solutions have the following advantages:

according to the technical solutions of the embodiments of the present disclosure, in addition to including a central curved surface and a bottom surface in the incident surface and a lateral surface, a first upper curved surface and a second upper curved surface in the emergent surface, the LED lens further includes scattering micro-structures located on the first upper curved surface and the second upper curved surface; the scattering micro-structures have positions corresponding to positions of bright rings in LED light intensity distribution, and scatter light transmitted from the first upper curved surface and the second upper curved surface and forming the bright rings, thereby scattering the light forming the bright rings slightly without changing a main propagation direction of light emitted from the LED light-emitting chip, reducing light intensity at the bright rings in the light intensity distribution of the LED light source, improving light intensity at dark rings in the light intensity distribution of the LED light source and improving uniformity of light intensity distribution of the LED light source.

### BRIEF DESCRIPTION OF THE DRAWINGS

In order to illustrate technical solutions in embodiments of the present disclosure or the conventional technology more clearly, hereinafter drawings to be used in the description of the embodiments or the conventional technology are introduced simply. Apparently the drawings described below are only some embodiments of the present disclosure, and other drawings may be obtained based on these drawings by those skilled in the art without any creative work.

FIG. 1 is a schematic structural diagram of an LED lens according to the conventional technology;

FIG. 2 is a schematic diagram showing distances from different positions on a central curved surface of the LED lens to an emitting center of the LED according to the conventional technology;

FIG. 3 is a schematic structural diagram of an LED lens according to an embodiment of the present disclosure;

FIG. 4 is a schematic enlarged diagram of a partial structure of an LED lens according to an embodiment of the present disclosure; and

FIG. 5 is a schematic diagram of a light path of a partial structure of an LED lens according to an embodiment of the present disclosure.

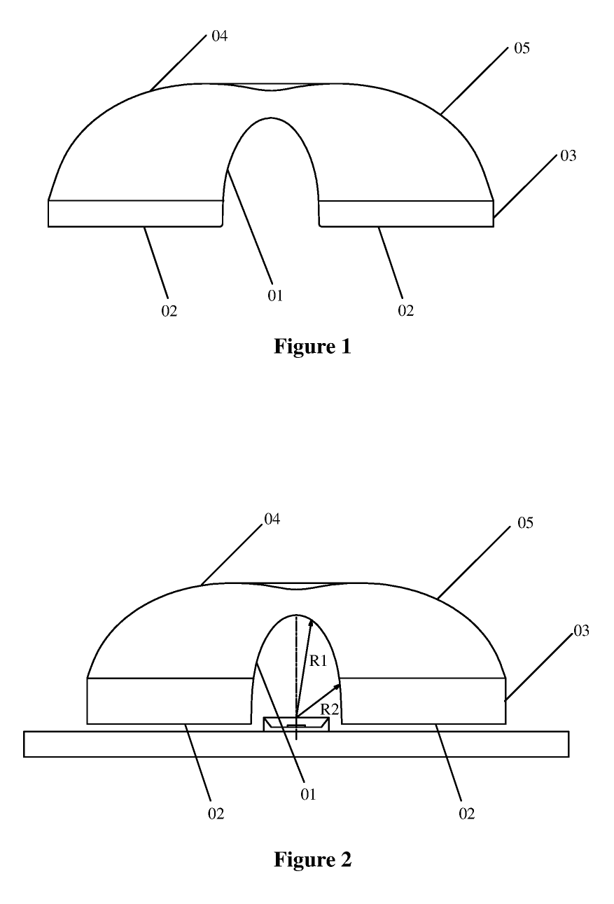

### DETAILED DESCRIPTION OF THE EMBODIMENTS

As described in the background, light emitted from the LED has poor uniformity after being transmitted from the conventional LED lens.

It is found through the inventor's research that, light itself emitted from the LED is not uniform, and the light presents bright-dark-bright appearance by taking a center of the LED as a starting point, i.e., forming multiple rings, with alternating a bright ring with a dark ring, thereby causing the light emitted from the LED and transmitted from the LED lens to still form multiple rings with alternating a bright ring with a dark ring, and having poor uniformity.

It is further found through the inventor's research that, the central curved surface 01 of the LED lens is a spherical cap curved surface, and a distance R from the central curved surface 01 to the emitting center (i.e., the LED) decreases as an emitting angle increases. As shown in FIG. 2, R2<R1, light intensity distribution of light emitted from the LED and transmitted from the LED lens, may be adjusted by adjusting the distance from a respective position on the central curved surface 01 to the emitting center. In practice, it is difficult to implement uniform optical distribution completely by adjusting the distance R from the respective position on the central curved surface 01 to the emitting center, and the optical design is difficult.

In view of the above, an LED lens is provided according to an embodiment of the present disclosure, which includes:

an incident surface, where the incident surface includes a central curved surface located at a center of the LED lens and an a bottom surface located around the central curved surface and connected to the central curved surface; and

an emergent surface, where the emergent surface includes a lateral surface perpendicular to and connected to the bottom surface and a first upper curved surface and a second upper curved surface connected to the lateral surface, and the first upper curved surface and the second upper curved surface are connected to each other and are symmetrical relative to an axis of the LED lens,

where the LED lens further includes:

scattering micro-structures located on the first upper curved surface and the second upper curved surface, where the scattering micro-structures have positions corresponding to positions of bright rings in LED light intensity distribution, and scatter light transmitted from the first upper curved surface and the second upper curved surface and forming the bright rings.

Accordingly, an LED light source is further provided according to an embodiment of the present disclosure, which includes:

an LED light-emitting chip and the LED lens described above, where the LED light-emitting chip is located within a cavity formed by the central curved surface and the bottom surface of the LED lens, and the scattering micro-structures in the LED lens have positions corresponding to positions of bright rings in light intensity distribution of the LED light-emitting chip.

It follows that, as compared with the conventional LED lens, according to the LED lens and the LED light source including the LED lens in the embodiment of the present disclosure, in addition to including a central curved surface and a bottom surface in the incident surface and a lateral surface, a first upper curved surface and a second upper curved surface in the emergent surface, the LED lens further includes scattering micro-structures located on the first upper curved surface and the second upper curved surface; the scattering micro-structures have positions corresponding to positions of bright rings in LED light intensity distribution, and scatter light transmitted from the first upper curved surface and the second upper curved surface and forming the bright rings, thereby scattering the light forming the bright rings slightly without changing a main propagation direction of light emitted from the LED light-emitting chip, reducing light intensity at the bright rings in the light intensity distribution of the LED light source, improving light intensity at dark rings in the light intensity distribution of the LED light source and improving uniformity of light intensity distribution of the LED light source.

In order to make the objects, features and advantages above of the present disclosure more obvious and easier to be understood, hereinafter specific implementations of the present disclosure are described in detail in conjunction with the drawings.

In order to understand the present disclosure fully, specific details are clarified in the following description. The present disclosure may be implemented by many other ways different from that described herein, and those skilled in the art may extend without departing from the connotation of the present disclosure. Hence the present disclosure is not limited by the disclosed specific implementations hereinafter.

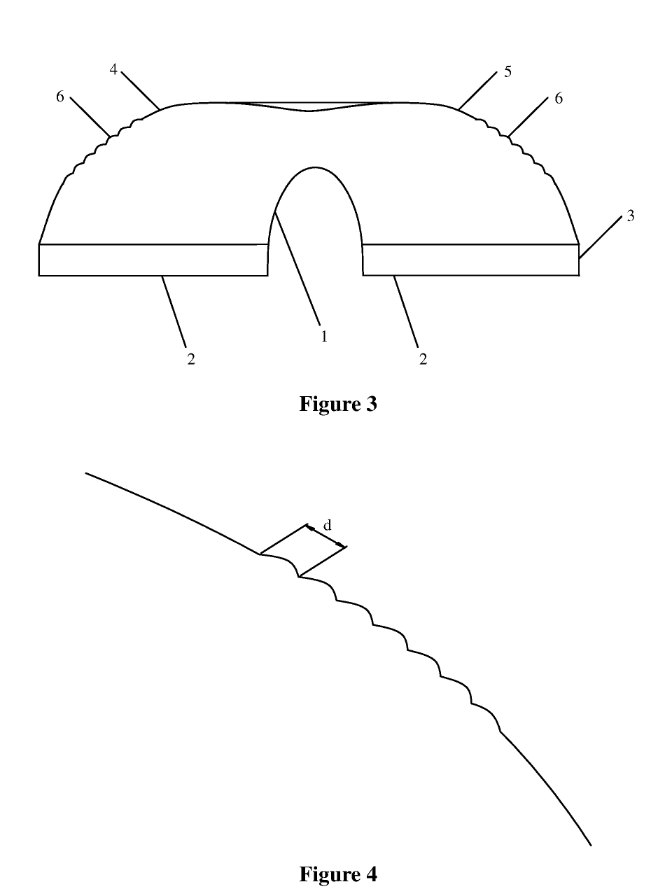

As shown in FIG. 3 and FIG. 4, an LED lens is provided according to an embodiment of the present disclosure, which includes:

an incident surface, where the incident surface includes a central curved surface 1 located at center of the LED lens and a bottom surface 2 located around the central curved surface 1 and connected to the central curved surface 1;

an emergent surface, where the emergent surface includes a lateral surface 3 perpendicular to and connected to the bottom surface 2 and a first upper curved surface 4 and a second upper curved surface 5 connected to the lateral surface 3, and the first upper curved surface 4 and the second upper curved surface 5 are connected to each other and are symmetrical relative to an axis of the LED lens; and

scattering micro-structures 6 located on the first upper curved surface 4 and the second upper curved surface 5, where the scattering micro-structures 6 have positions corresponding to positions of bright rings in LED light intensity distribution, and scatter light transmitted from the first upper curved surface 4 and the second upper curved surface 5 and forming the bright rings.

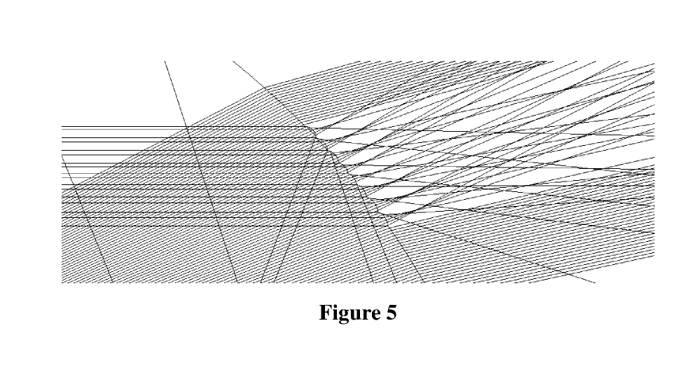

As compared with the conventional LED lens, the LED lens according to the embodiment of the present disclosure further includes the scattering micro-structures 6 located on the first upper curved surface 4 and the second upper curved surface 5; and the scattering micro-structures 6 have positions corresponding to positions of bright rings in LED light intensity distribution and scatter light transmitted from the first upper curved surface 4 and the second upper curved surface 5 and forming the bright rings, such that light with respective emergent angles mixes as shown in FIG. 5, and a part of light which should have been focused at the bright rings in light intensity distribution of the LED light source are scattered to dark rings in the light intensity distribution of the LED light source, thereby reducing light intensity at the bright rings in the light intensity distribution of the LED light source, improving light intensity at the dark rings in the light intensity distribution of the LED light source and improving uniformity of light intensity distribution on a receiving surface, i.e., an irradiation surface, of light emitted from the LED light source.

In an embodiment of the present disclosure, as shown in FIG. 4, the scattering micro-structure 6 is a ring-shaped structure parallel to the bottom surface 2, such that the light is scattered slightly without changing a main propagation direction of the light, and light that should have been focused at the bright rings is scattered to dark rings adjacent to the bright rings, thereby reducing light intensity at the bright rings, improving light intensity at the dark rings, and improving uniformity of the light emitted from the LED and then transmitted by the LED lens, i.e., improving uniformity of light intensity distribution on a receiving surface of the light emitted from the LED.

Based on any of the embodiments above, in an embodiment of the present disclosure, projections of adjacent scattering micro-structures 6 on the bottom surface 2 adjoin end to end, i.e., other than projections of two ends of the scattering micro-structure 6, projections of the adjacent scattering micro-structures 6 do not overlap, such that light transmitted from a certain point on the first upper curved surface 4 or the second upper curved surface 5 of the LED lens is not scattered by multiple scattering micro-structures 6, and a scattering effect is not influenced.

Based on any of the embodiments above, in another embodiment of the present disclosure, preferably a distance between two ends of the scattering micro-structure 6 is greater than 0 μm and less than or equal to 100 μm, and more preferably the distance may be 20 μm, 30 μm or 50 μm, such that an original main propagation direction of the light is not changed and the original propagation direction of the light is prevented from being changed excessively due to the scattering micro-structures 6 to reduce uniformity of the light emitted from the LED and then transmitted from the LED lens.

Based on any of the embodiments above, in another embodiment of the present disclosure, preferably the scattering micro-structure 6 is an axisymmetric structure, such that a part of light focused at the bright rings originally is uniformly scattered to dark rings adjacent to the bright rings, thereby further improving uniformity of the light emitted from the LED and then transmitted from the LED lens.

Based on any of the embodiments above, in another embodiment of the present disclosure, the scattering micro-structures 6 are located in a region in which an angle between the lateral surface 3 and the bottom surface 2 has a range of 60 degrees to 90 degrees, inclusive, i.e., a region other than the light having half light intensity emitted from the LED, such that light with a large emergent angle is scattered, so that a part of the light is scattered to a receiving surface (i.e., an irradiation surface), and another part of the light is scattered to an extra reflection plate and reflected to the receiving surface, thereby improving light energy on the receiving surface.

It should be noted that, preferably the LED lens according to the embodiments of the present disclosure is fabricated using integral forming process, and more preferably the LED lens is fabricated using an injection molding process. Specifically, a lens model corresponding to the LED lens according to the embodiment of the present disclosure is fabricated using a single point diamond lathe process technology; and the LED lens according to the embodiment of the present disclosure is fabricated based on the lens model using the injection molding process.

Specifically, in an embodiment of the present disclosure, the lens model corresponding to the LED lens according to the embodiment of the present disclosure being fabricated using the single point diamond lathe process technology may be fabricated by moving an X coordinate and a Y coordinate of a position of a scattering micro-structure 6 for a certain displacement in a certain direction in a case that the conventional LED lens is fabricated using the single point diamond lathe process technology. In other embodiments of the present disclosure, the LED lens may be fabricated using other methods as needed, which is not limited in the present disclosure.

In summary, in addition to including the central curved surface 1 and the bottom surface 2 in the incident surface and the lateral surface 3, the first upper curved surface 4 and the second upper curved surface 5 in the emergent surface, the LED lens according to the embodiment of the present disclosure further includes the scattering micro-structures 6 located on the first upper curved surface 4 and the second upper curved surface 5. The scattering micro-structures 6 have positions corresponding to positions of bright rings in LED light intensity distribution, and scatter light transmitted from the first upper curved surface 4 and the second upper curved surface 5 and forming the bright rings, such that the light forming the bright rings is scattered slightly without changing a main propagation direction of light emitted from the LED light-emitting chip, and light with respective emergent angles mixes, thereby reducing light intensity at the bright rings in the light intensity distribution of the LED light source, improving light intensity at the dark rings in the light intensity distribution of the LED light source, and improving uniformity of light intensity distribution on an irradiation surface of the light emitted from the LED.

Accordingly, an LED light source is further provided according to an embodiment of the present disclosure, which includes an LED light-emitting chip and the LED lens according to any of the embodiments above. The LED lens includes: an incident surface, where the incident surface includes a central curved surface located at a center of the LED lens and a bottom surface located around the central curved surface and connected to the central curved surface; an emergent surface, where the emergent surface includes a lateral surface perpendicular to and connected to the bottom surface and a first upper curved surface and a second upper curved surface connected to the lateral surface, the first upper curved surface and the second upper curved surface are connected to each other and are symmetrical relative to an axis of the LED lens; and scattering micro-structures located on the first upper curved surface and the second upper curved surface, where the scattering micro-structures have positions corresponding to positions of bright rings in LED light intensity distribution, and scatter light transmitted from the first upper curved surface and the second upper curved surface and forming the bright rings. The LED light-emitting chip is locate in a cavity formed by the central curved surface and the bottom surface of the LED lens, and the scattering micro-structures in the LED lens have positions corresponding to positions of bright rings in light intensity distribution of the LED light-emitting chip.

It follows that, in the LED light source according to the embodiment of the present disclosure, in addition to including the central curved surface and the bottom surface in the incident surface and the lateral surface, the first upper curved surface and the second upper curved surface in the emergent surface, the LED lens further includes scattering micro-structures located on the first upper curved surface and the second upper curved surface, the scattering micro-structures have positions corresponding to positions of bright rings in LED light intensity distribution, and scatter light transmitted from the first upper curved surface and the second upper curved surface and forming the bright rings, such that the light forming the bright rings is scattered slightly without changing a main propagation direction of light emitted from the LED light-emitting chip, and light with respective emergent angles mixes, thereby reducing light intensity at the bright rings in the light intensity distribution of the LED light source, improving light intensity at dark rings in the light intensity distribution of the LED light source and improving uniformity of light intensity distribution on an irradiation surface of the LED light source.

Respective parts of the specification are described in a progressive way, each part lays emphasis on the difference from other parts, and the same or similar content of the respective parts may be referred to each other.

According to the above description of the disclosed embodiments, those skilled in the art can implement or practice the present disclosure. Many changes to these embodiments are apparent for those skilled in the art and general principles defined herein may be implemented in other embodiments without departing from the spirit or scope of the present disclosure. Hence, the present disclosure is not limited by the disclosed embodiments but to conform to the widest scope in accordance with principles and novelty disclosed herein.

1. An LED lens, comprising:
an incident surface, wherein the incident surface comprises a central curved surface located at a center of the LED lens and a bottom surface located around the central curved surface and connected to the central curved surface; and
an emergent surface, wherein the emergent surface comprises a lateral surface perpendicular to and connected to the bottom surface and a first upper curved surface and a second upper curved surface connected to the lateral surface, and the first upper curved surface and the second upper curved surface are connected to each other and are symmetrical relative to an axis of the LED lens,
wherein the LED lens further comprises:
scattering micro-structures located on the first upper curved surface and the second upper curved surface, wherein the scattering micro-structures have positions corresponding to positions of bright rings in LED light intensity distribution, and scatter light transmitted from the first upper curved surface and the second upper curved surface and forming the bright rings.

2. The LED lens according to claim 1, wherein the scattering micro-structures are located in a region in which an angle between the lateral surface and the bottom surface has a range of 60 degrees to 90 degrees, inclusive.

3. The LED lens according to claim 1, wherein the scatter micro-structure is a ring-shaped structure parallel to the bottom surface.

4. The LED lens according to claim 3, wherein projections of adjacent ones of the scattering micro-structures on the bottom surface adjoins end to end.

5. The LED lens according to claim 4, wherein a distance between two ends of the scattering micro-structure is greater than 0 μm and less than or equal to 100 μm.

6. The LED lens according to claim 5, wherein the scattering micro-structure is an axisymmetric structure.

7. The LED lens according to claim 1, wherein the LED lens is fabricated using an injection molding process.

8. An LED light source, comprising:
an LED light-emitting chip and an LED lens,
wherein, the LED lens comprises:
an incident surface, wherein the incident surface comprises a central curved surface located at a center of the LED lens and a bottom surface located around the central curved surface and connected to the central curved surface; and
an emergent surface, wherein the emergent surface comprises a lateral surface perpendicular to and connected to the bottom surface and a first upper curved surface and a second upper curved surface connected to the lateral surface, and the first upper curved surface and the second upper curved surface are connected to each other and are symmetrical relative to an axis of the LED lens,
wherein the LED lens further comprises:
scattering micro-structures located on the first upper curved surface and the second upper curved surface, wherein the scattering micro-structures have positions corresponding to positions of bright rings in LED light intensity distribution, and scatter light transmitted from the first upper curved surface and the second upper curved surface and forming the bright rings,
wherein the LED light-emitting chip is located within a cavity formed by the central curved surface and the bottom surface of the LED lens, and the scattering micro-structures in the LED lens have positions corresponding to positions of bright rings in light intensity distribution of the LED light-emitting chip.

9. The LED light source according to claim 8, wherein the scattering micro-structures are located in a region in which an angle between the lateral surface and the bottom surface has a range of 60 degrees to 90 degrees, inclusive.

10. The LED light source according to claim 8, wherein the scatter micro-structure is a ring-shaped structure parallel to the bottom surface.

11. The LED light source according to claim 10, wherein projections of adjacent ones of the scattering micro-structures on the bottom surface adjoins end to end.

12. The LED light source according to claim 11, wherein a distance between two ends of the scattering micro-structure is greater than 0 μm and less than or equal to 100 μm.

13. The LED light source according to claim 12, wherein the scattering micro-structure is an axisymmetric structure.

14. The LED light source according to claim 8, wherein the LED lens is fabricated using an injection molding process.

15. The LED lens according to claim 2, wherein the scatter micro-structure is a ring-shaped structure parallel to the bottom surface.
